(19) United States
(12) Patent Application Publication
(10) Pub. No.: US 2025/0299677 A1
(43) Pub. Date: Sep. 25, 2025

(54) SILENT SPEECH COMMUNICATION SYSTEM AND METHOD THEREOF USING ATTACHABLE OPTICAL SENSOR

(71) Applicant: Electronics and Telecommunications Research Institute, Daejeon (KR)

(72) Inventors: Seong Jae LIM, Daejeon (KR); Chang Joon PARK, Daejeon (KR)

(73) Assignee: Electronics and Telecommunications Research Institute, Daejeon (KR)

(21) Appl. No.: 18/937,309

(22) Filed: Nov. 5, 2024

(30) Foreign Application Priority Data
Mar. 21, 2024 (KR) 10-2024-0038977
Aug. 19, 2024 (KR) 10-2024-0110470

(51) Int. Cl. G10L 15/24; G02B 6/42; G10L 13/027; G10L 13/04

(52) U.S. Cl. CPC G10L 15/24; G02B 6/424; G10L 13/027; G10L 13/04

(57) ABSTRACT

Disclosed are a silent speech communication system and a method thereof using an attachable optical sensor, the attachable optical sensor including optical fiber layers, a support member, and light receivers, wherein each optical fiber layer may include optical fibers arranged horizontally in a grid structure, a plurality of optical fiber layers is provided and may be arranged in layers in a vertical direction relative to each other, the support member may include optical fibers arranged in the vertical direction, the support member may vertically connect the plurality of optical fiber layers arranged in the layers in the vertical direction to each other, and light sources may be connected to one side of the optical fibers included in each optical fiber layer and one side of the optical fibers included in the support member, so as to supply light to the optical fibers.

### CROSS REFERENCE TO RELATED APPLICATION

The present application claims priority to Korean Patent Application No. 10-2024-0038977, filed Mar. 21, 2024, and 10-2024-0110470, filed Aug. 19, 2024, the entire contents of which are incorporated herein for all purposes by this reference.

### BACKGROUND OF THE INVENTION

### Field of the Invention

The technology described below relates to a silent speech communication system.

### Description of the Related Art

The technology of silent speech interfaces is one of technologies that enables users to communicate without actually uttering any sound. Silent speech interfaces are one of the techniques in which the users such as those with hearing or speech impairments, those with difficulty speaking accurately due vocal cord to laryngectomy or deformities, and those military/police/firefighting/security personnel having to communicate while wearing a mask are enabled to communicate even without voice. Among the silent speech interfaces, the silent speech-type voice recognition technology, which allows communication by using only mouth shapes without actual voice, has characteristics that are robust against ambient noise, communication security, etc.

### DOCUMENTS OF RELATED ART

### Non-Patent Documents

Paper published: Machine Learning Methods for Automatic Silent Speech Recognition Using a Wearable Graphene Strain Gauge Sensor (published on Dec. 31, 2021)

### SUMMARY OF THE INVENTION

Conventionally, in silent speech interface technologies, there are a technology for capturing and using air coming out of the mouth of a person, a technology for capturing and using facial movements of the person, etc. However, these conventional technologies have issues such as requiring sound of levels higher than or equal to a certain level (e.g., 35 db(A)) or affecting performance depending on photographing angles and the presence or absence of light. In particular, there is a problem in that a range of recognizable pronunciations is very limited, making it difficult to use in everyday life or in wartime and operational situations.

An objective of technology described below is to disclose a silent speech communication system enabling language communication by using only subtle movements of a person's skin without using an actual voice.

The technology described below discloses an attachable optical sensor, a silent speech communication system, and a silent speech communication method.

In one of exemplary embodiments of the technology described below, there may be provided an attachable optical sensor including: optical fiber layers; a support member; light sources; and light receivers, wherein each optical fiber layer may include optical fibers arranged horizontally in a grid structure, a plurality of optical fiber layers may be arranged in layers in a vertical direction relative to each other, the support member may include optical fibers arranged in the vertical direction, the support member may vertically connect the plurality of optical fiber layers arranged in the layers in the vertical direction to each other, the light sources may be connected to one side of the optical fibers included in each optical fiber layer and one side of the optical fibers included in the support member, so as to supply light to the optical fibers, and the light receivers may be connected to the other side of the optical fibers included in each optical fiber layer and the other side of the optical fibers arranged in the support member, so as to sense the light passing through the optical fibers.

In one of exemplary embodiments of the technology described below, there may be provided a silent speech communication system including: a sensor unit for obtaining light sensing data by using an attachable optical sensor; a data processing unit including an inference module for generating sound data on the basis of the light sensing data; and a speaker unit for outputting sound on the basis of the sound data.

In one of exemplary embodiments of the technology described below, there may be provided a silent speech communication method, the method including: obtaining light sensing data by a sensor unit; generating sound data on the basis of the light sensing data by an inference module included in a data processing unit; and outputting sound corresponding to the sound data by a speaker unit.

When the technology described below is used, a user's skin movements may be detected.

When the technology described below is used, people may converse with each other on the basis of the results of detecting the user's skin movements.

When the technology described below is used, personnel are enabled to communicate with each other even without voice in wartime and military operational situations. In addition, this technology is robust against loud ambient noise and may solve problems such as communication security.

When the technology described below is used, this technology is applicable to not only silent speech interfaces but also muscle and joint movement measurement, thereby helping people diagnose and rehabilitate musculoskeletal diseases. This technology allows conversation by detecting the user's skin movements.

### BRIEF DESCRIPTION OF THE DRAWINGS

In one of exemplary embodiments, FIGS. 1 to 3 illustrate one of examples of an attachable optical sensor 100 including two optical fiber layers.

FIG. 1 is a perspective view illustrating the attachable optical sensor 100 according to an exemplary embodiment.

FIG. 2 is a top view illustrating the attachable optical sensor 100 according to the exemplary embodiment.

FIG. 3 is a view illustrating a power communication unit 140 included in the attachable optical sensor 100 according to the exemplary embodiment.

In one of the exemplary embodiments, FIG. 4 is a view illustrating an appearance of the attachable optical sensor 100 attached to a person's tongue.

In one of the exemplary embodiments, FIG. 5 is a view illustrating one of examples of a silent speech communication system 200.

In one of the exemplary embodiments, FIG. 6 is a view illustrating one of the examples of implementing the silent speech communication system.

In one of the exemplary embodiments, FIG. 7 is a view illustrating one example 300 of the examples of the silent speech communication system performing a silent speech communication method thereof.

### DETAILED DESCRIPTION OF THE INVENTION

The technology described below may be applied with various changes and may have various exemplary embodiments. The drawings in the specification may describe specific exemplary embodiments of the technology described below. However, this is for description of the technology described below and is not intended to limit the technology described below to specific exemplary embodiments. Therefore, it should be understood that all changes, equivalents, or substitutes included in the idea and technical scope of the technology described below are included in the technology described below.

Terms such as first, second, A, B, etc. may be used to describe various components. However, the terms are only used to distinguish one component from other components and are not intended to limit the corresponding components by the terms. For example, without departing from the scope of the technology described below, a first component may be referred to as a second component, and similarly, the second component may be referred to as the first component. The term “and/or” includes a combination of a plurality of related and described items, or any of the plurality of related and described items.

In the terms used below, singular expressions should be understood to include plural expressions unless the context clearly interprets otherwise. It should be understood that the term “includes”, “comprises”, or the like mean that the described feature, number, step, operation, component, part, or combination thereof exists, but do not preclude possibilities of the presence or addition of one or more other features or numbers, steps, operations, components, parts, or combinations thereof.

Prior to a detailed description of the drawings, it should be clarified that the classification of components in the present specification is merely a classification for each main function of each corresponding component. That is, it may be provided such that two or more components described below may be combined into one component, or one component may be divided into two or more components for each more subdivided function. Further, in addition to its main functions in charge, each component to be described below may additionally perform some or all of the functions of other components in charge, and naturally, some of the main functions of each component in charge may also be exclusively performed by other components

In addition, in performing a method or method of operation, each process constituting the method may be performed in a different order from a specified order unless a specific order is clearly described in context. That is, each process may be performed in the same order as specified, may be performed substantially simultaneously, or may be performed in a reverse order.

In one of exemplary embodiments, an attachable optical sensor may be a sensor used in a silent speech communication system. Alternatively, the attachable optical sensor may be a sensor applicable to measure a person's muscle movements, etc.

The attachable optical sensor is attachable to a person's body. For example, the attachable optical sensor may be attached to the top or bottom of a tongue, the roof of a mouth, the floor of the mouth, lips, cheeks, vocal cords in a throat, arms, legs, etc. of a person.

The attachable optical sensor may sense subtle changes or movements of the person's skin. The attachable optical sensor may measure the skin's subtle changes or movements that occur when silent speech is uttered.

The attachable optical sensor may include optical fibers. The optical fibers included in the attachable optical sensor may change depending on subtle changes or movements of the skin. The optical fibers included in the attachable optical sensor may stretch or compress depending on the subtle changes or movements of the skin. As the optical fibers change, the paths, intensities, or phases of light passing through inside the optical fibers may change. Based on such changes, the changes or movements of the skin may be sensed.

The attachable optical sensor may include a plasmonic strain material instead of the optical fibers. Accordingly, the attachable optical sensor may enable highly sensitive strain detection by detecting changes in Localized Surface Plasmon Resonance (LSPR).

The attachable optical sensor may include optical fibers arranged horizontally in a grid structure. When a force is applied to the attachable optical sensor in X-axis and Y-axis directions thereof, changes may occur in the optical fibers included in an optical fiber layer. Accordingly, the optical fibers included in the optical fiber layer may sense the force applied in the X-axis and Y-axis directions.

The attachable optical sensor may include optical fibers arranged in a vertical direction thereof. When a force is applied to the attachable optical sensor in a Z direction thereof, a change may occur in the optical fibers arranged in the vertical direction. For example, when the attachable optical sensor is attached to a person's tongue, if pressure in the Z-axis direction is applied to the attachable optical sensor due to a person's tongue, teeth, or the like, a change may occur in the optical fibers included in a support member. Accordingly, the attachable optical sensor may measure the pressure.

The attachable optical sensor may measure not only two-dimensional subtle changes or movements of a person's skin but also three-dimensional subtle changes or movements of the skin through the horizontally arranged optical fibers and vertically arranged optical fibers.

In one of the exemplary embodiments, an attachable optical sensor may include optical fiber layers, light sources, light receivers, and a support member. Furthermore, the attachable optical sensor may further include a power communication unit and an adhesive patch unit. Each optical fiber layer may include optical fibers. Each optical fiber layer may include horizontally arranged optical fibers. Each optical fiber layer may include the optical fibers in a grid structure. Each optical fiber layer may include the optical fibers arranged horizontally in the grid structure.

There may exist a plurality of optical fiber layers. The plurality of optical fiber layers may be arranged in layers in a vertical direction relative to each other. Each of the plurality of optical fiber layers may have the shape, form, and structure same as or different from each other.

The support member may include optical fibers. The support member may include optical fibers arranged in a vertical direction thereof.

The support member may connect the plurality of optical fiber layers to each other. The support member may vertically connect the plurality of optical fiber layers to each other. The support member may vertically connect the plurality of optical fiber layers arranged in the layers in the vertical direction to each other.

Light sources may be connected to one sides of the optical fibers. The light sources may be connected to one sides of the optical fibers included in each optical fiber layer. Light sources may be connected to one sides of optical fibers included in the support member. The light sources may supply light to the optical fibers. The light sources may be connected to one sides of the optical fibers included in each optical fiber layer and one sides of the optical fibers included in the support member, thereby supplying light to the optical fibers.

Light receivers may be connected to the other side of the optical fibers. The light receivers may be connected to the other side of the optical fibers included in each optical fiber layer. Light receivers may be connected to the other side of the optical fibers included in the support member. The light receivers may sense light passing through the optical fibers. The light receivers are connected to the other side of the optical fibers included in each optical fiber layer and the other side of the optical fibers included in the support member, thereby sensing light passing through the optical fibers. The light receivers may sense at least one of paths, intensities and phases of light passing through inside the optical fibers.

Each of the plurality of optical fiber layers may have the shape, form, and structure same as or different from each other. For example, the plurality of optical fiber layers may have a rectangular shape same as each other. Alternatively, some of the plurality of optical fiber layers may have a circular shape and the remainder may have a rectangular shape.

The light sources and light receivers may be present in each layer constituted by the plurality of optical fiber layers. For example, in a case where there exist three optical fiber layers in an attachable optical sensor, each layer may have light sources and light receivers, so that there may be a total of three light sources and three light receivers in the attachable optical sensor.

Some of the optical fibers included in the support member may be connected to a light source included in an upper optical fiber layer and a light receiver included in a lower optical fiber layer. The remainder of the optical fibers may be connected to a light source included in the lower optical fiber layer and a light receiver included in the upper optical fiber layer.

A power communication unit may supply power to the light sources and the light receivers.

The power communication unit may transmit and receive light sensing data. The power communication unit may transmit and receive the light sensing data. To this end, the power communication unit may use near-field magnetic induction (NFMI) technology. By using the NFMI technology, power-efficient short-range wireless charging and data transmission/reception may be enabled for short-range power sources and wireless receivers. In addition, the power communication unit is manufacturable as an ultra-small strain chip, which is flexible and very small, so as to be usable by attaching it to a person's skin in patch form. In addition, by using the NFMI strain chip, the power communication unit is operable at very low power and is robust against radio frequency (RF) interference, thereby enabling short-range communications that are secure from eavesdropping.

The adhesive patch unit may allow the attachable optical sensor to be attachable to a person's skin. The adhesive patch unit is harmless to the person's body, is attachable for several hours, and is resistant to waste materials such as saliva and sweat.

The adhesive patch unit may include an adhesive material that reacts with saliva to generate adhesive strength. The adhesive patch unit may include an adhesive material that melts and disappears when cured over time after being attached. For example, the adhesive material may include raw materials such as ethyl cellulose, PVP, glycerin, or silicone.

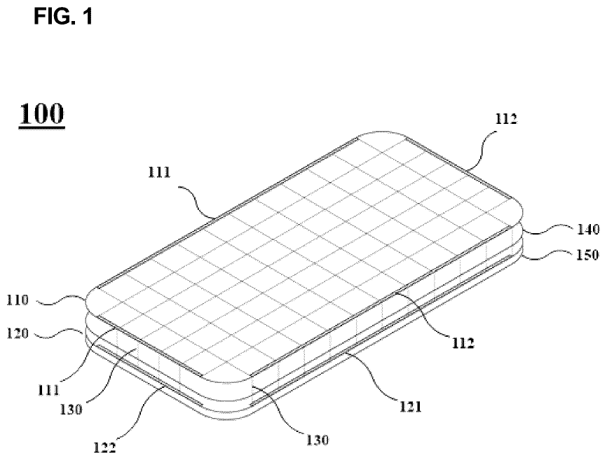

In one of exemplary embodiments, FIGS. 1 to 3 illustrate one of examples of the attachable optical sensor 100 including two optical fiber layers. Hereinafter, for convenience of description, each component is named as a first optical fiber layer 110, a first light source 111, a first light receiver 112, a second optical fiber layer 120, a second light source 121, and a second light receiver 122.

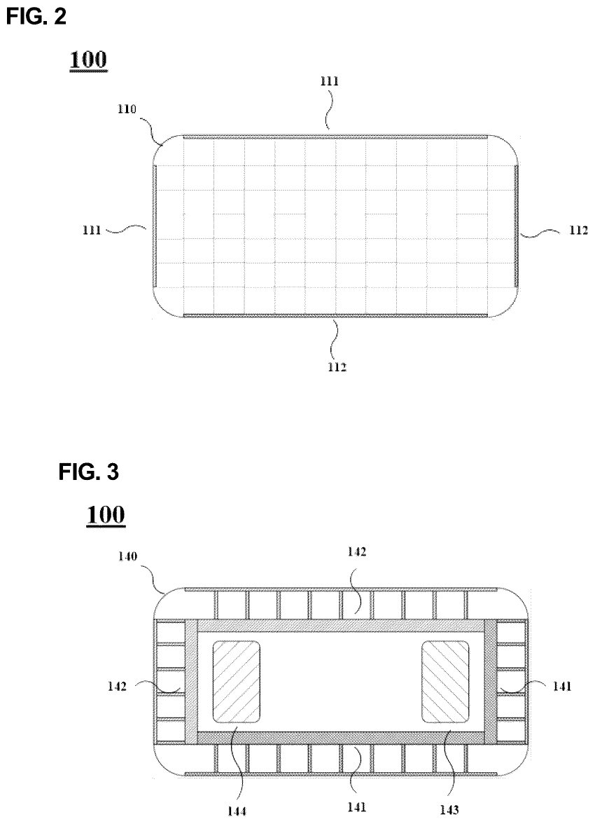

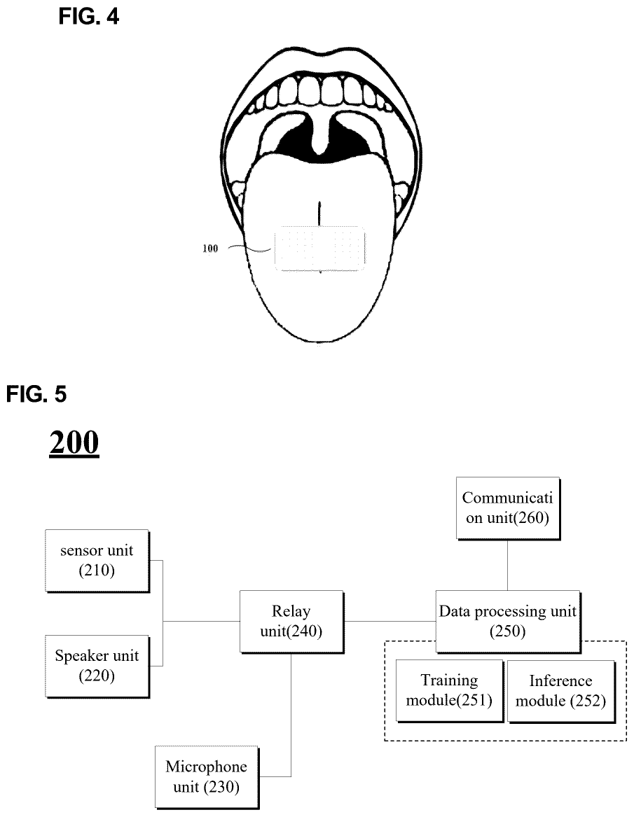

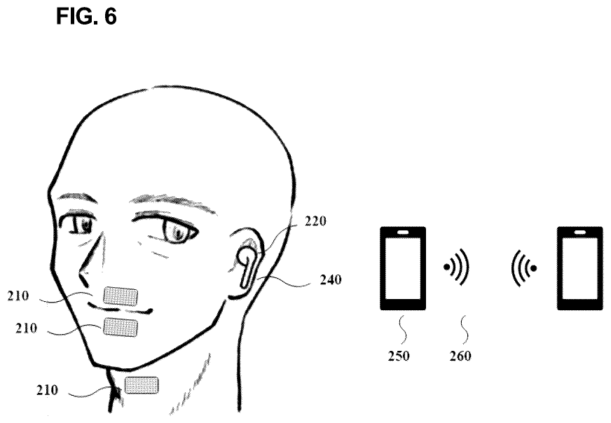

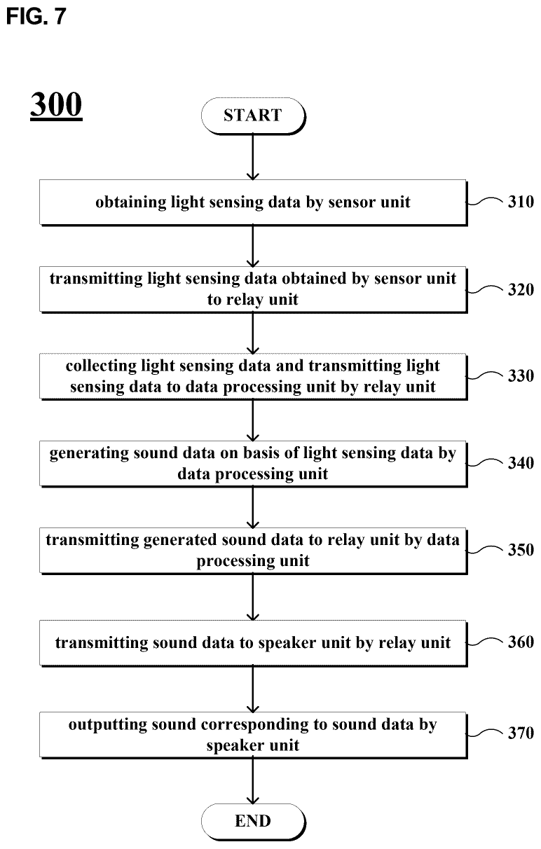

FIG. 1 is a perspective view illustrating the attachable optical sensor 100 according to an exemplary embodiment. FIG. 2 is a top view illustrating the attachable optical sensor 100 according to the exemplary embodiment. FIG. 3 is a view illustrating a power communication unit 140 included in the attachable optical sensor 100 according to the exemplary embodiment.

The attachable optical sensor 100 may include a first optical fiber layer 110, a first light source 111, a first light receiver 112, a second optical fiber layer 120, a second light source 121, a second light receiver 122, and a support member 130. Furthermore, the attachable optical sensor 100 may further include a power communication unit 140 and an adhesive patch unit 150.

Each of the first optical fiber layer 110 and the second optical fiber layer 120 may include optical fibers arranged horizontally in a grid structure. The support member 130 may include optical fibers arranged in a vertical direction. The first optical fiber layer 110 and the second optical fiber layer 120 may be arranged in layers in the vertical direction relative to each other. The first optical fiber layer 110 and the second optical fiber layer 120 may respectively be located at the upper and lower sides. The support member 130 may vertically connect the first optical fiber layer 110 and the second optical fiber layer 120 to each other, which are arranged in the layers in the vertical direction.

The light source 111 and light receiver 112 and the light source 121 and light receiver 122 may respectively be present in the first optical fiber layer 110 and the second optical fiber layer 120.

The first light source 111 may be located along two adjacent sides of the first optical fiber layer 110. The first light receiver 112 may be located along two adjacent sides of the first optical fiber layer 110. The first light receiver 112 may be located along the two adjacent sides on the opposite side of the first light source 111 in the first optical fiber layer 110.

The first light source 111 may be connected to one side of the optical fibers included in the first optical fiber layer 110. The first light source 111 may supply light into inside the optical fibers included in the first optical fiber layer 110. The first light receiver 112 may be connected to the other side of the optical fibers included in the first optical fiber layer 110. The first light receiver 112 may sense light passing through the optical fibers included in the first optical fiber layer 110.

The second light source 121 may be located along two adjacent sides of the second optical fiber layer 120. The second light receiver 122 may be located along two adjacent sides of the second optical fiber layer 120. The second light receiver 122 may be located along the two adjacent sides on the opposite side of the second light source 121 in the second optical fiber layer 120.

The second light source 121 may be connected to one side of the optical fibers included in the second optical fiber layer 120. The second light source 121 may supply light inside the optical fibers included in the second optical fiber layer 120. The second light receiver 122 may be connected to the other side of the optical fibers included in the second optical fiber layer 120. The second light receiver 122 may sense light passing through the optical fibers included in the second optical fiber layer 120.

A portion of the optical fibers included in the support member 130 may be connected between the first light source 111 and the second light receiver 122. The first light source 111 may be connected to one side of the portion of the optical fibers included in the support member 130. The second light receiver 122 may be connected to the other side of the portion of the optical fibers included in the support member 130.

The remainder of the optical fibers included in the support member 130 may be connected between the second light source 121 and the first light receiver 112. The second light source 121 may be connected to one side of the remaining optical fibers included in the support member 130. The first light receiver 112 may be connected to the other side of the remaining optical fibers included in the support member 130.

The power communication unit 140 may be located between the first optical fiber layer 110 and the second optical fiber layer 120.

The power communication unit 140 may include: a battery 141 for supplying power; a data collector 142 for collecting light sensing data from light receivers; a power receiver 143 for receiving power from an NFMI microchip through short-range wireless communication; and a data transmitter 144 configured with an NFMI antenna that transmits the light sensing data. In this case, the NFMI microchip has a unique ID and may transmit data along with the NFMI ID when transmitting the data. The power communication unit 140 may be supplied with power by using the NFMI technology.

The adhesive patch unit 150 may be located on a lower side of the second optical fiber layer 120. The adhesive patch unit 150 enables the attachable optical sensor 100 to be attachable to a person's skin.

In one of the exemplary embodiments, FIG. 4 is a view illustrating an appearance of the attachable optical sensor 100 attached to a person's tongue. As shown in FIG. 4, the attachable optical sensor 100 may be located on the top of the tongue. Accordingly, the attachable optical sensor 100 may detect the movement of the tongue and obtain light sensing data. This is just one of examples, and the attachable optical sensor 100 is not necessarily required to be attached to the tongue. The attachable optical sensor 100 may be attached any site where the same is attachable to the skin of the person. In addition, the attachable optical sensor 100 may be used to measure movements of muscles and joints as well as to apply the silent speech interface, and may also be used to diagnose musculoskeletal diseases or provide rehabilitation treatment.

In one of the exemplary embodiments, FIG. 5 is a view illustrating one of examples of a silent speech communication system 200.

The silent speech communication system 200 may include a sensor unit 210, a speaker unit 220, a microphone unit 230, a relay unit 240, a data processing unit 250, and a communication unit 260. The sensor unit 210, speaker unit 220, microphone unit 230, relay unit 240, data processing unit 250, and communication unit 260, which are included in the silent speech communication system 200, may be implemented as respective separate devices, but may also be implemented as a single device or a plurality of devices. For example, an earphone may include a speaker, a microphone, and a repeater. Alternatively, a sensor unit 210, a microphone unit 230, and a relay unit 240 may be included within one sensor.

The sensor unit 210 may obtain light sensing data by using an attachable optical sensor. The sensor unit 210 may obtain the light sensing data by using the attachable optical sensor such as that described above in FIG. 1, etc.

The speaker unit 220 may output sound. The speaker unit 220 may output the sound to a user. The speaker unit 220 may be physically implemented in various ways. For example, the speaker unit 220 may be implemented in the form of an earphone, an earbud, a headset, etc.

The speaker unit 220 may output sound corresponding to sound data received from the relay unit 240. The sound data received by the speaker unit 220 may be data about sound obtained by inference from light sensing data.

The microphone unit 230 may obtain sound. The microphone unit 230 may obtain the sound for a user's voice. The microphone unit 230 may be physically implemented in various ways.

The microphone unit 230 may obtain sound data corresponding to the voice spoken by a user to whom the sensor unit 210 is attached. The sound data obtained by the microphone unit 230 may become training data required to create an analysis model.

The relay unit 240 may transmit or receive data to or from the sensor unit 210, speaker unit 220, microphone unit 230, and data processing unit 250. The relay unit 240 may perform wireless and/or wired communications with the sensor unit 210, speaker unit 220, microphone unit 230, and data processing unit 250. For example, the relay unit 240 may receive light sensing data from the sensor unit 210. The relay unit 240 may transmit sound data to the speaker unit 220. The relay unit 240 may receive sound data from the microphone unit 230. The relay unit 240 may transmit and receive the light sensing data and sound data to and from the data processing unit 250.

The relay unit 240 may include a chip for wireless communication and/or wireless power transmission. For example, the relay unit 240 may include an NFMI microchip.

The relay unit 240 may be located in close proximity to the sensor unit 210. Since the relay unit 240 is located in the close proximity to the sensor unit 210, the relay unit 240 may perform the wireless communication and/or wireless power transmission with the sensor unit 210. For example, since the relay unit 240 is located in the close proximity to the sensor unit 210, the relay unit 240 may perform the NFMI-based wireless communication and/or wireless power transmission with the sensor unit 210. The supplying of wireless power or transmitting of data may be performed between the relay unit 240 and the power communication unit 140 through NFMI chips mutually mounted thereon. When the NFMI chips are utilized, the efficient power supply and wireless transmission may be performed without complex wiring. Power may be wirelessly supplied from the relay unit 240 to an optical sensor through the NFMI chips. Through the NFMI chips, the power communication unit 140 may wirelessly transmit light sensing data to the relay unit.

The data processing unit 250 may perform data processing, operations, etc., which are required for the operation of the silent speech communication system 200. The data processing unit 250 may perform operations required for the silent speech communication method. The data processing unit may be a device that includes a processor for processing certain operations, an application processor (AP), and a chip having an embedded program. For example, an operation device 930 may include a Central Processing Unit (CPU), a Graphics Processing Unit (GPU), a Neural Processing Unit (NPU), or the like.

The data processing unit 250 may be physically implemented in various forms. For example, the data processing unit 250 may take the form of a PC, laptop, smart device, server, data processing-dedicated chipset, or the like.

The data processing unit 250 may include an inference module 252 and a training module 251.

The inference module 252 may generate sound data on the basis of light sensing data. The inference module 252 may generate the sound data, corresponding to the light sensing data, on the basis of the light sensing data.

The inference module 252 may generate sound data based on light sensing data by using an analysis model. The inference module 252 may input the light sensing data into the trained analysis model and then generate the sound data on the basis of output values of the analysis model. The analysis model used by the inference module 252 may be a model trained by the training module 251.

The sound data generated by the inference module 252 may be transmitted to the speaker unit 220. The sound data generated by the inference module 252 may be transmitted to the speaker unit 220 through the relay unit 240. The speaker unit 220 may output sound to a user on the basis of the transmitted sound data.

The training module 251 may train an analysis model on the basis of training data.

The training module 251 may create the training data for training the analysis model on the basis of the light sensing data obtained by the sensor unit 210 and the sound data obtained by the microphone unit 230. For example, the training module 251 may create the training data for training the analysis model by pairing the light sensing data obtained by the sensor unit 210 and the user's voice data obtained by the microphone unit 230.

The training module 251 may store the created training data in a database. The user's light sensing data and the user's sound data may be recorded in the database. The user-specific speech voice and the characteristics of light sensing data may be recorded in the database.

The training module 251 may train the analysis model after preprocessing the training data. For example, the training module 251 may convert the training data into a form suitable for training the analysis model by performing preprocessing such as removing noise from the training data, performing normalization, performing dimension reduction (i.e., PCA, t-SNE), etc.

The analysis model may be a model that generates sound data, corresponding to light sensing data, from the light sensing data.

The analysis model may be a machine learning (ML)-based model. The machine learning-based model may be a model that learns from data to identify specific targets or conditions, or be a model that finds and classifies patterns in the data. Various types of machine learning-based models may be provided therefor. For example, various machine learning-based models may include a decision tree, a random forest (RF), a K-nearest neighbor (KNN), a Naive Bayes classifier, a support vector machine (SVM), an artificial neural network (ANN), etc. The ANN may be a Deep Neural Network (DNN), which may also include a Convolutional Neural Network (CNN), a Recurrent Neural Network (RNN), a Restricted Boltzmann Machine (RBM), a Deep Belief Network (DBN), a Generative Adversarial Network (GAN), a Relation Networks (RL), etc.

The analysis model may be a model that performs an attention mechanism. The analysis model may generate sound data by focusing more on data required to generate the sound data from light sensing data. For example, the analysis model may generate the sound data by focusing more on the data affected by the movements of the tongue, lips, vocal cords, and the like in the light sensing data.

The analysis model may include an encoder-decoder structure. An encoder may compress light sensing data and extract only a portion therefrom required to generate sound data. A decoder may generate the sound data on the basis of information extracted by the encoder.

The communication unit 260 may transmit or receive data through wired or wireless communication. The communication unit 260 may transmit or receive light sensing data. The inference module 252 may generate sound data on the basis of the light sensing data received by the communication unit 260. The communication unit 260 may also transmit or receive the sound data. By having the communication unit 260 receive light sensing data and sound data from a third party other than a user, the user and the third party may perform silent speech communication.

In one of the exemplary embodiments, FIG. 6 is a view illustrating one of the examples of implementing the silent speech communication system.

The sensor unit 210 may include at least one or more attachable optical sensors. The attachable optical sensors may be attached to a person's philtrum, lower jaw, and neck area near the vocal cords. An earphone may include a relay unit 240 and a speaker unit 220. The relay unit 240 may receive light sensing data from the at least one or more attachable optical sensors. The relay unit 240 may collect the light sensing data received from the at least one or more attachable optical sensors and then transmit the light sensing data to the data processing unit 250. The data processing unit 250 may generate sound data on the basis of the received light sensing data. The data processing unit 250 may be implemented in the form of a smartphone. The communication unit 260 may transmit the light sensing data and sound data to another data processing unit, or receive the light sensing data and sound data from another data processing unit. The speaker unit 220 may output sound on the basis of the sound data. In this way, the person is enabled to hear sounds through skin movements even without direct sound. In addition, the person may communicate and converse with a third party by hearing sounds based on the third party's light sensing data.

In one of the exemplary embodiments, FIG. 7 is a view illustrating one example 300 of the examples of the silent speech communication system performing a silent speech communication method.

In step 310, a sensor unit may obtain light sensing data. For example, when a speaker's silent speech begins, the sensor unit may obtain the light sensing data according to subtle changes or movements of the speaker's skin through an attachable optical sensor attached around the vocal cords of the person's throat. In step 320, the sensor unit may transmit the obtained light sensing data to a relay unit. The relay unit may be implemented in the form of an earphone or as a part of the earphone. In step 330, the relay unit may transmit the received light sensing data to a data processing unit. The data processing unit may be a smartphone. In step 340, the data processing unit may generate sound data on the basis of the received light sensing data. In step 350, the data processing unit may transmit the generated sound data to the relay unit. In step 360, the relay unit may transmit the sound data to a speaker unit. The speaker unit may be implemented in the form of the earphone or as the part of the earphone. In step 370, the speaker unit may output sound corresponding to the sound data.

What is claimed is:

1. An attachable optical sensor comprising:
optical fiber layers;
a support member;
light sources; and
light receivers,
wherein each optical fiber layer comprises optical fibers arranged horizontally in a grid structure,
a plurality of optical fiber layers is arranged in layers in a vertical direction relative to each other,
the support member comprises optical fibers arranged in the vertical direction,
the support member vertically connects the plurality of optical fiber layers arranged in the layers in the vertical direction to each other,
the light sources are connected to one side of the optical fibers comprised in each optical fiber layer and one side of the optical fibers comprised in the support member, so as to supply light to the optical fibers, and
the light receivers are connected to the other side of the optical fibers comprised in each optical fiber layer and the other side of the optical fibers arranged in the support member, so as to sense the light passing through the optical fibers.

2. The attachable optical sensor of claim 1, wherein a light source and a light receiver are present in each layer constituted by the plurality of optical fiber layers.

3. The attachable optical sensor of claim 2, wherein a portion of the optical fibers comprised in the support member is connected to the light source comprised in an upper optical fiber layer and the light receiver comprised in a lower optical fiber layer, and
a remainder of the optical fibers comprised therein is connected to the light source comprised in the lower optical fiber layer and the light receiver comprised in the upper optical fiber layer.

4. The attachable optical sensor of claim 1, wherein the light receivers sense at least one of paths, intensities and phases of the light passing through inside the optical fibers.

5. The attachable optical sensor of claim 1, wherein each of the plurality of optical fiber layers has a shape, a form, and a structure same as or different from each other.

6. The attachable optical sensor of claim 1, further comprising:
a power communication unit,
wherein the power communication unit comprises:
a battery for supplying power;
a data collector for collecting light sensing data from the light receivers; and
a data transmitter for transmitting the light sensing data.

7. The attachable optical sensor of claim 1, further comprising:
an adhesive patch unit,
wherein the adhesive patch unit comprises an adhesive material enabling the attachable optical sensor to be attached to a person's skin.

8. A silent speech communication system comprising:
a sensor unit for obtaining light sensing data by using an attachable optical sensor;
a data processing unit comprising an inference module for generating sound data on the basis of the light sensing data; and
a speaker unit for outputting sound on the basis of the sound data,
wherein the attachable optical sensor is an attachable optical sensor of claim 1.

9. The silent speech communication system of claim 8, further comprising:
a relay unit capable of transmitting or receiving the data to or from the sensor unit, the data processing unit, and the speaker unit.

10. The silent speech communication system of claim 8, wherein the inference module generates the sound data on the basis of the light sensing data by using an analysis model, and
the analysis model is a trained model trained on the basis of training data.

11. The silent speech communication system of claim 10, wherein the analysis model is an artificial neural network (ANN)-based model and comprises a model capable of performing an attention mechanism that focuses more on data required to generate the sound data from the light sensing data.

12. The silent speech communication system of claim 10, wherein the analysis model comprises an encoder-decoder structure.

13. The silent speech communication system of claim 8, further comprising:
a communication unit capable of transmitting or receiving at least one of the light sensing data and the sound data.

14. The silent speech communication system of claim 8, further comprising:
a microphone unit for obtaining the sound for a user's voice,
wherein the data processing unit further comprises a training module, and
the training module creates training data required for training an analysis model to be used by the inference module on the basis of the light sensing data obtained by the sensor unit and the sound of the user's voice obtained by the microphone unit.

15. A silent speech communication method, the method being performed by a silent speech communication system of claim 8, and the method comprising:
obtaining light sensing data by a sensor unit;
generating sound data on the basis of the light sensing data by an inference module comprised in a data processing unit; and
outputting sound corresponding to the sound data by a speaker unit.

16. The silent speech communication method of claim 15, further comprising:
transmitting or receiving, by a relay unit, data to or from the sensor unit, the data processing unit, and the speaker unit,
wherein the silent speech communication system further comprises the relay unit.

17. The silent speech communication method of claim 15, wherein the inference module generates the sound data on the basis of the light sensing data by using an analysis model, and
the analysis model is a trained model trained on the basis of training data.

18. The silent speech communication method of claim 15, further comprising:
transmitting or receiving, by a communication unit, at least one of the light sensing data and the sound data,
wherein the silent speech communication system further comprises the communication unit.

19. The silent speech communication method of claim 15, further comprising:
obtaining the sound for the user's voice by a microphone unit; and
creating, by a training module comprised in the data processing unit, training data required for training an analysis model to be used by the inference module on the basis of the light sensing data obtained by the sensor unit and the sound for the user's voice obtained by the microphone unit,
wherein the silent speech communication system further comprises the microphone unit, and
the data processing unit further comprises the training module.
